(19) United States
(12) Patent Application Publication
(10) Pub. No.: US 2021/0117653 A1
(43) Pub. Date: Apr. 22, 2021

(54) IMAGING DEVICE AND SMART IDENTIFICATION METHOD

(71) Applicant: TRIPLE WIN TECHNOLOGY(SHENZHEN) CO.LTD., Shenzhen (CN)

(72) Inventor: YU-AN CHO, New Taipei (TW)

(21) Appl. No.: 16/713,396

(22) Filed: Dec. 13, 2019

(30) Foreign Application Priority Data
Oct. 18, 2019 (CN) 201910996069.7

(51) Int. Cl. G06K 9/00; G06T 7/73

(52) U.S. Cl. CPC G06K 9/00281; G06T 7/73; G06K 9/00201; G06K 9/00248

(57) ABSTRACT

A smart identification method is applied to an imaging device. The smart identification method includes acquiring an image, identifying the feature information of the image according to a preset instruction, searching for the target information corresponding to the feature information of the image in a pre-stored correspondence table, and outputting the target information according to a preset rule.

### FIELD

The subject matter herein generally relates to a smart identification method, and more particularly to a smart identification method implemented in an imaging device.

### BACKGROUND

Imaging devices such as cameras are used for security and testing purposes. However, the imaging device generally only has a photographing function, and a user cannot acquire other information related to the photographed image.

### BRIEF DESCRIPTION OF THE DRAWINGS

Implementations of the present disclosure will now be described, by way of embodiments, with reference to the attached figures.

FIG. 1 is a block diagram of an embodiment of an imaging device.

FIG. 2 is a flowchart diagram of a smart identification method implemented in the imaging device.

FIG. 3 is a function module diagram of a smart identification system.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “comprising” means “including, but not necessarily limited to”; it specifically indicates open-ended inclusion or membership in a so-described combination, group, series and the like.

In general, the word “module” as used hereinafter refers to logic embodied in hardware or firmware, or to a collection of software instructions, written in a programming language such as, for example, Java, C, or assembly. One or more software instructions in the modules may be embedded in firmware such as in an erasable-programmable read-only memory (EPROM). It will be appreciated that the modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

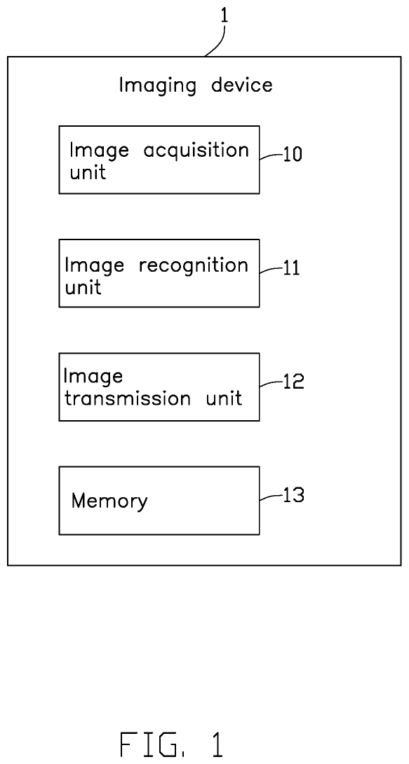

FIG. 1 shows an embodiment of an imaging device. The imaging device 1 includes an image acquisition unit 10, an image recognition unit 11, an image transmission unit 12, and a memory 13. The memory 13 may store program instructions, which can be executed by the image recognition unit 11.

The imaging device 1 may be any one of a camera, a video camera, and a monitor.

The image acquisition unit 10 may be a photosensitive device for converting an optical signal collected by a lens into an electrical signal to form a digital image.

The image recognition unit 11 may be a central processing unit (CPU) having an image recognition function, or may be another general-purpose processor, a digital signal processor (DSP), an application specific integrated circuit (ASIC), a Field-Programmable Gate Array (FPGA), or other programmable logic devices, discrete gate or transistor logic devices, discrete hardware components, or the like. The general purpose processor may be a microprocessor or any processor in the art.

The image transmission unit 12 may be a chip having a wireless transmission function including, but not limited to, WIFI, BLUETOOTH, 4G 5G and the like.

The memory 13 can be used to store the program instructions which are executed by the image recognition unit 11 to realize various functions of the imaging device 1.

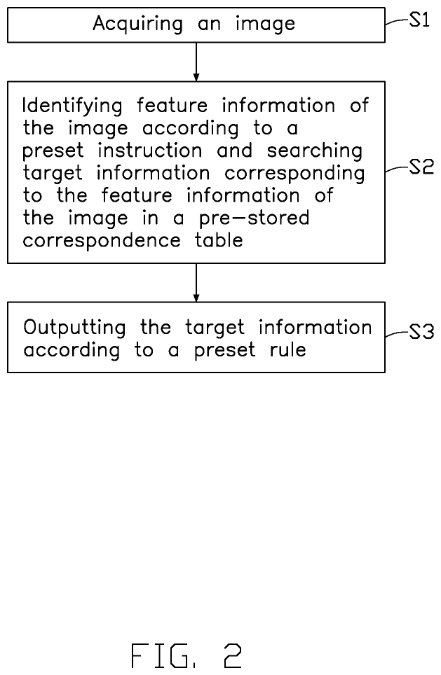

FIG. 2 shows a flowchart of a smart identification method applied to an imaging device. The order of blocks in the flowchart may be changed according to different requirements, and some blocks may be omitted.

In block S1, an image is acquired.

In one embodiment, a reflected light signal of an object to be photographed is acquired by the image acquisition unit 10, and the reflected light signal is converted into an electrical signal to form a digital image. Then, the image acquisition unit 10 transmits the digital image to the image recognition unit 11.

In block S2, the feature information of the image is identified according to a preset instruction, and target information corresponding to the feature information of the image is searched in a pre-stored correspondence table.

In one embodiment, the preset instruction is input by a user, and the instruction information may include the feature information of an image to be identified. The feature information includes, but is not limited to, one or more of the facial feature information, the behavioral feature information, the item feature information (item type, item name, item quantity, etc.), and the environmental feature information. The correspondence table between the feature information and the target information may store a correspondence between the facial feature information and the target information, a correspondence between the behavioral feature information and the target information, a correspondence between the item feature information and the target information, and a correspondence between the environmental feature information and the target information.

For example, the image recognition unit 11 accepts identification information of a person in the image input by a user, extracts the facial feature information in the image to be recognized, compares the extracted facial feature information to the correspondence table, and determines a correspondence relationship between the facial feature information and the target information. The target information includes personal identification information corresponding to the facial feature information and parameter information of the imaging device corresponding to the facial feature information.

For example, the camera device 1 located at a bank ATM acquires the facial image of a bank employee through the image acquisition unit 10 and transmits the facial image to the image recognition unit 11. The image recognition unit 11 recognizes the facial feature information in the facial image and compares the facial feature information to the facial feature information in the correspondence table to determine whether the facial feature information matches target information in the correspondence table.

In another example, when a person takes a photo through the imaging device 1 on a mobile phone, the photo is acquired by the image acquisition unit 10, and the photo is sent to the image recognition unit 11. The image recognition unit 11 identifies the facial feature information from the photo, searches the correspondence table to determine whether the facial feature information matches target information in the correspondence table, searches for the parameter information of the imaging device 1 corresponding to the facial feature information, and applies the parameter information to adjust image parameters of the photo.

In one embodiment, the image recognition unit 11 accepts a behavioral feature information instruction of an image input by a user, extracts the behavioral feature information from the image, compares the extracted behavioral feature information to the correspondence table, and determines whether the extracted behavioral feature information matches target information in the correspondence table according to the correspondence relationship.

In another embodiment, the image recognition unit 11 further compares the extracted behavioral feature information to a code of conduct table and determines whether the extracted behavioral feature information corresponds to behavioral information in the code of conduct table. For example, the code of conduct table includes preset behaviors which are designated to occur or not occur within designated time periods, preset behaviors which are designated as harmful to others, and preset behaviors which are designated as harmful to the environment. If the behavioral feature information matches an incorrect behavior recorded in the code of conduct table, a first prompt is issued. For example, the image acquisition unit 10 located in a factory acquires an image of an employee smoking. The image is sent to the image recognition unit 11. The image recognition unit 11 extracts the behavioral feature information from the image, compares the extracted behavioral feature information to the code of conduct table, and determines that the extracted behavioral feature information matches behavior which is harmful to others. Thus, a prompt is issued by email, phone, or the like.

In one embodiment, the image recognition unit 11 accepts an item feature information instruction of an image input by a user, extracts the item feature information from the image, compares the extracted item feature information to the item feature information in the correspondence table, and determines whether the extracted item feature information matches any item feature information in the correspondence table to determine the corresponding target information. The target information includes an item name, an item quantity, and the like.

In another embodiment, the method further includes determining whether the item is located in a preset area and issuing a second prompt if the item is not located in the preset area. The method for determining whether the item is located in a preset area includes acquiring an image when the item is located in a preset area, marking a position of a reference object in the image and a position of the item in the preset area, calculating a distance and orientation between the item and the reference object, and storing the distance and orientation information in an item and reference object comparison table. The reference object is located in the preset area or a predetermined distance from the preset area. The method further includes acquiring an image of the item to be identified, identifying the distance and orientation between the item to be identified and the reference object in the image, and comparing the identified distance and orientation between the item and reference object to the stored distance and orientation in the item and reference object comparison table. If the identified distance and orientation are inconsistent with the stored distance and orientation, it is determined that the item is not located in the preset area.

For example, the imaging device 1 located in an exhibition hall captures an image through the image acquisition unit 10 and transmits the image to the image recognition unit 11. The image recognition unit 11 recognizes the item information in the image and compares the item information to the correspondence table to determine whether the item information matches any target information. The item name of the item in the image is determined by the correspondence between the matching item feature information and the target information in the correspondence table. If the identified item name does not match the name of the item in the exhibition, it means that the exhibit has been lost or dropped.

In other embodiments, the method further includes acquiring an image of the exhibit at a preset position, and the image acquisition unit 10 transmits the image of the exhibit at the preset position to the image recognition unit 11, and the image recognition unit 11 identifies the distance and orientation between the preset position and the reference object in the image, and the distance and orientation are compared to the position and orientation in the item and reference object comparison table. The reference object may be an object located in the preset area or at a predetermined distance from the preset area, and may be a pillar, a table on which the exhibit is placed, or the like. When the imaging device 1 in the exhibition hall monitors the exhibit in real time, the image acquisition unit 10 acquires an image of the exhibit and transmits the image to the image recognition unit 11, which recognizes the exhibit in the image and compares the distance and orientation between the exhibit and the reference object according to the item position and reference position comparison table to determine whether the exhibit is displaced.

In one embodiment, the image recognition unit 11 accepts an environmental feature information instruction of an image input by a user, extracts the environmental feature information from the image, compares the extracted environmental feature information to the correspondence table, determines whether the extracted environmental feature information matches any environmental feature information according to the correspondence relationship, and determines the target environmental feature information according to the matching environmental feature information. The target environmental information includes the weather information and human flow density information in a preset area. The identified weather information may be used to adjust collection parameters of the image collection unit 10, and the identified human flow density information may be sent to a designated person for personnel scheduling.

In block S3, the target information is output according to a preset rule.

The preset rule may include one or more of picture annotation display, voice information, short message, mail, telephone, and alarm. For example, when the imaging device 1 is a camera, the personal identification information and the item name information recognized by the image recognition unit 11 can be displayed on a side of the image. When the imaging device 1 is a monitor display, the behavioral information may be displayed on a side of the image, or the behavioral information, the human flow density information, and the item position information may be sent by text message, mail, phone, alarm, or voice message to corresponding personnel.

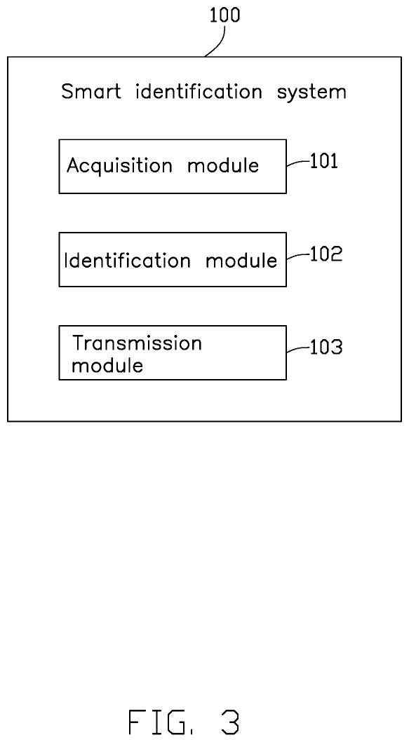

FIG. 3 shows a function module diagram of a smart identification system 100 applied in the imaging device 1.

The function modules of the smart identification system 100 may be stored in the memory 13 and executed by at least one processor, such as the image recognition unit 11, to implement functions of the smart identification system 100. In one embodiment, the function modules of the smart identification device 100 may include an acquisition module 101, an identification module 102, and a transmission module 103.

The acquisition module 101 is configured to acquire an image. Details of functions of the acquisition module 101 are described in block S1 in FIG. 2 and will not be described further.

The identification module 102 is configured to identify the feature information of the image according to a preset instruction, and search for the target information corresponding to the feature information of the image in a pre-stored correspondence table between the feature information and the target information. Details of functions of the identification module 102 are described in block S2 in FIG. 2 and will not be described further.

The transmission module 103 is configured to output the target information according to a preset rule. Details of functions of the transmission module 103 are described in block S3 in FIG. 3 and will not be described further.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A smart identification method applicable in an imaging device, the smart identification method comprising:
acquiring an image;
identifying feature information of the image according to a preset instruction, and searching for target information corresponding to the feature information of the image in a pre-stored correspondence table; and
outputting the target information according to a preset rule.

2. The smart identification method of claim 1, wherein:
the feature information comprises one or more of facial feature information, behavioral feature information, item feature information, and environmental feature information.

3. The smart identification method of claim 2, wherein when the feature information is the facial feature information, the method further comprises:
identifying the feature information in the image according to a preset instruction;
extracting the facial feature information in the image to be recognized;
comparing extracted facial feature information to the feature information in the correspondence table;
determining matching facial feature information in the correspondence table according to a result of comparing the extracted facial feature information to the feature information in the correspondence table; and
determining the target information corresponding to the matching facial feature information; wherein:
the target information comprises at least one of personal identification information corresponding to the facial feature information and parameter information of the imaging device corresponding to the facial feature information.

4. The smart identification method of claim 2, wherein when the feature information is the behavioral feature information, the method further comprises:
identifying the feature information in the image according to a preset instruction;
extracting the behavioral feature information in the image to be recognized;
comparing the extracted behavioral feature information to the feature information in the correspondence table;
determining matching behavioral feature information in the correspondence table according to a result of comparing the extracted behavioral feature information to the feature information in the correspondence table; and
determining the target information corresponding to the matching behavioral feature information; wherein:
the target information is a behavior corresponding to the behavioral feature information.

5. The smart identification method of claim 4, further comprising:
obtaining the behavioral feature information, and comparing the behavioral feature information to a code of conduct table;
determining whether the behavioral feature information corresponds to the behavioral information in the code of conduct table; and
issuing a first prompt if the behavioral feature information matches an incorrect behavior recorded in the code of conduct table; wherein:
the code of conduct table comprises preset behaviors which should occur and which should not occur within designated time periods, preset behaviors which are designated as harmful to others, and preset behaviors which are designated as harmful to the environment.

6. The smart identification method of claim 2, wherein when the feature information is the item feature information, the method further comprises:
identifying the feature information in the image according to a preset instruction;
extracting the item feature information in the image to be recognized;
comparing extracted item feature information to the feature information in the correspondence table;
determining matching item feature information in the correspondence table according to a result of comparison of the extracted item feature information to the feature information in the correspondence table; and
determining the target information corresponding to the matching item feature information; wherein:
the target information comprises at least one of an item name, an item quantity, item characteristics.

7. The smart identification method of claim 6, further comprising:
determining whether an item is in a preset area; and
issuing a second prompt when the item is not in the preset area.

8. The smart identification method of claim 7, wherein the method of determining whether the item is in the preset area comprises:
acquiring an image when the item is located in the preset area;
marking a position of a reference object in the image and a position of the item in the preset area;
calculating a distance and an orientation between the item and the reference object, and storing distance information and orientation information in an item and reference object comparison table;
acquiring an image of the item to be identified, determining a distance and an orientation between the item to be identified and the reference object in the image, and comparing an identified distance and an identified orientation between the item and reference object to stored distance information and orientation information in the item and reference object comparison table; and
determining that the item is not located in the preset area if the determined distance and the determined orientation are inconsistent with the stored distance and orientation.

9. The smart identification method of claim 2, wherein when the feature information is the environmental feature information, the method further comprises:
identifying the feature information in the image according to a preset instruction;
extracting the environmental feature information in the image to be recognized;
comparing extracted environmental feature information to the feature information in the correspondence table;
determining matching environmental feature information in the correspondence table according to a result of comparison of the extracted environmental feature information to the feature information in the correspondence table; and
determining the target information corresponding to the matching environmental feature information; wherein:
the target information comprises at least one of weather information and human flow density information in a preset area.

10. An imaging device comprising:
an image acquisition unit configured to convert an optical signal collected by a lens into an electrical signal to form a digital image;] an image recognition unit configured to implement a plurality of instructions for identifying the digital image;
an image transmission unit configured to transmit the digital image or the identified digital image; and
a memory configured to store the plurality of instructions, which when implemented by the image recognition unit, cause the image recognition unit to:
acquire an image;
identify the feature information of the image according to a preset instruction, and search for the target information corresponding to the feature information of the image in a pre-stored correspondence table; and
output the target information according to a preset rule.

11. The imaging device of claim 10, wherein:
the feature information comprises one or more of facial feature information, behavioral feature information, item feature information, and environmental feature information.

12. The imaging device of claim 11, wherein when the feature information is the facial feature information, the image acquisition unit is configured to:
identify the feature information in the image according to a preset instruction;
extract the facial feature information in the image to be recognized;
compare extracted facial feature information to the feature information in the correspondence table;
determine matching facial feature information in the correspondence table according to a result of comparing the extracted facial feature information to the feature information in the correspondence table; and
determine the target information corresponding to the matching facial feature information; wherein:
the target information comprises at least one of personal identification information corresponding to the facial feature information and parameter information of the imaging device corresponding to the facial feature information.

13. The imaging device of claim 11, wherein when the feature information is behavioral feature information, the image acquisition unit is configured to:
identify the feature information in the image according to a preset instruction;
extract the behavioral feature information in the image to be recognized;
compare the extracted behavioral feature information to the feature information in the correspondence table;
determine matching behavioral feature information in the correspondence table according to a result of comparing the extracted behavioral feature information to the feature information in the correspondence table; and
determine the target information corresponding to the matching behavioral feature information; wherein:
the target information is a behavior corresponding to the behavioral feature information.

14. The imaging device of claim 13, wherein the image recognition unit is further configured to:
obtain the behavioral feature information, and comparing the behavioral feature information to a code of conduct table;
determine whether the behavioral feature information corresponds to the behavioral information in the code of conduct table; and
issue a first prompt if the behavioral feature information matches an incorrect behavior recorded in the code of conduct table; wherein:
the code of conduct table comprises preset behaviors which are designated to occur or not occur within preset time periods, preset behaviors which are designated as harmful to others, and preset behaviors which are designated as harmful to the environment.

15. The imaging device of claim 11, wherein when the feature information is the item feature information, the image acquisition unit is configured to:
identify the feature information in the image according to a preset instruction;
extract the item feature information in the image to be recognized;
compare extracted item feature information to the feature information in the correspondence table;
determine matching item feature information in the correspondence table according to a result of comparison of the extracted item feature information to the feature information in the correspondence table; and
determine the target information corresponding to the matching item feature information; wherein:
the target information comprises at least one of an item name, an item quantity, item characteristics.

16. The imaging device of claim 15, wherein the image recognition unit is further configured to:
determining whether an item is in a preset area; and
issuing a second prompt when the item is not in the preset area.

17. The imaging device of claim 16, wherein the image recognition unit determines whether the item is in the preset area by:
acquiring an image when the item is located in the preset area;
marking a position of a reference object in the image and a position of the item in the preset area;
calculating a distance and an orientation between the item and the reference object, and storing distance information and orientation information in an item and reference object comparison table;
acquiring an image of the item to be identified, determining a distance and an orientation between the item to be identified and the reference object in the image, and comparing an identified distance and an identified orientation between the item and reference object to stored distance information and orientation information in the item and reference object comparison table; and
determining that the item is not located in the preset area if the determined distance and the determined orientation are inconsistent with the stored distance and orientation.

18. The imaging device of claim 11, wherein when the feature information is the environmental feature information, the image recognition unit is configured to:
identify the feature information in the image according to a preset instruction;
extract the environmental feature information in the image to be recognized;
compare extracted environmental feature information to the feature information in the correspondence table;
determine matching environmental feature information in the correspondence table according to a result of comparison of the extracted environmental feature information to the feature information in the correspondence table; and
determine the target information corresponding to the matching environmental feature information; wherein:
the target information comprises at least one of weather information and human flow density information in a preset area.
